(19) United States
(12) Patent Application Publication
(10) Pub. No.: US 2024/0298560 A1
(43) Pub. Date: Sep. 12, 2024

(54) SYSTEM AND METHOD FOR DETERMINING SHANK ATTACHMENT MEMBER LOSS OF AN AGRICULTURAL IMPLEMENT

(71) Applicant: CNH Industrial America LLC, Racine, WI (US)

(72) Inventor: Brittany Schroeder, Bunker Hill, IN (US)

(21) Appl. No.: 18/120,067

(22) Filed: Mar. 10, 2023

(51) Int. Cl. A01B 35/22; A01B 76/00; G01S 7/41; G01S 13/88

(52) U.S. Cl. CPC A01B 35/225; A01B 76/00; G01S 7/41; G01S 13/88

(57) ABSTRACT

Agricultural implements typically include ground-engaging tools, such as replaceable shanks and shank attachment members (e.g., tillage points), to condition the soil of a field. Unfortunately, when a shank attachment member falls off or otherwise decouples from its respective shank during operation, the shank attachment member is typically difficult to find and expensive to replace. The shank may also need to be replaced if the implement is operated for an extended period without a shank attachment member. As such, an agricultural implement includes radar sensors configured to emit output signals directed at a portion of a field positioned aft of the shanks and to receive reflections of the output signals as echo signals, and a computing system configured to determine when the shank attachment member has detached from the shank based on the echo signals.

### FIELD OF THE INVENTION

The present subject matter relates generally to agricultural implements and, more particularly, to systems and related methods for determining shank attachment member loss of ground-engaging tools of an agricultural implement.

### BACKGROUND OF THE INVENTION

A wide range of agricultural implements have been developed and are presently in use for tilling, cultivating, harvesting, and so forth. Tillage implements, for example, are commonly towed behind tractors and may cover wide swaths of ground that include various types of residues. Such residues may include materials left in the field after the crop has been harvested (e.g., stalks and stubble, leaves, and seed pods). Good management of field residue can increase efficiency of irrigation and control of erosion in the field.

Tillage implements typically include ground-engaging tools, such as shanks and shank attachment members (e.g., tillage points, chisels, etc.), configured to condition the soil for improved moisture distribution while reducing soil compaction from sources such as machine traffic, grazing cattle, or standing water. The shank attachment members are typically replaceable and come in a wide variety to accommodate different field conditions and the desired results of the tilling operation. Unfortunately, when a shank attachment member falls off or otherwise decouples from its respective shank during operation, the shank attachment member is typically difficult to find and expensive to replace, and the shank may also need to be replaced if the implement is operated for an extended period without a shank attachment member, which further increases the cost of a lost shank attachment member.

Accordingly, an improved system and method for determining shank attachment member loss of ground-engaging tools of an agricultural implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural implement. The agricultural implement generally includes a frame and a ground-engaging tool coupled to the frame. The ground-engaging tool includes a shank and a shank attachment member coupled to the shank. The agricultural implement also includes a first radar sensor configured to emit output signals directed at a portion of a field positioned aft of the ground-engaging tool. Additionally, the first radar sensor is configured to receive reflections of the output signals as echo signals. Furthermore, the agricultural implement includes a computing system communicatively coupled to the first radar sensor. The computing system is configured to determine a density profile of the portion of the field positioned aft of the ground-engaging tool based on the echo signals received by the first radar sensor. Moreover, the computing system is configured to determine when the shank attachment member has detached from the shank based on the determined density profile.

In another aspect, the present subject matter is directed to a system for determining shank attachment member loss of a ground-engaging tool of an agricultural implement. The system includes a ground-engaging tool including a shank and a shank attachment member coupled to the shank. Additionally, the system includes a first radar sensor configured to emit output signals directed at a portion of a field positioned aft of the ground-engaging tool. The first radar sensor is also configured to receive reflections of the output signals as echo signals. Furthermore, the system includes a second radar sensor configured to emit output signals directed at a portion of a field positioned fore of the ground-engaging tool. The second radar sensor is also configured to receive reflections of the output signals as echo signals. Moreover, the system includes a computing system communicatively coupled to the first radar sensor and the second radar sensor. The computing system is configured to determine a density profile of the portion of the field positioned aft of the ground-engaging tool based on the echo signals received by the first radar sensor. Likewise, the computing system is configured to determine a density profile of the portion of the field positioned fore of the ground-engaging tool based on the echo signals received by the second radar sensor. Additionally, the computing system is configured to compare the determined density profiles of the portions of the field positioned aft and fore of the ground-engaging tool based on the echo signals received by the first radar sensor and the second radar sensor. Furthermore, the computing system is configured to determine that the shank attachment member has detached from the shank based on the comparison of the determined density profiles.

In a further aspect, the present subject matter is directed to a method for determining shank attachment member loss of a ground-engaging tool of an agricultural implement. The method includes receiving, with a computing device, reflections of radar sensor output signals as echo signals. Additionally, the method includes generating, with the computing device, a representation of the condition of the field positioned aft of the ground-engaging tool based on the received echo signals. Furthermore, the method includes comparing, with the computing device, the generated representation of the condition of the field positioned aft of the ground-engaging tool to a predetermined representation of the condition of the field positioned aft of the ground-engaging tool. Moreover, the method includes determining, with the computing device, that the shank attachment member has detached from the shank when the comparison of the generated representation to the predetermined representation is indicative of a presence of the shank attachment member or an untilled soil condition of the field.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural implement in accordance with aspects of the present subject matter;

FIG. 2 illustrates a side view of a shank assembly of the agricultural implement shown in FIG. 1, particularly illustrating a shank attachment member coupled to a shank in accordance with aspects of the present subject matter:

FIG. 3 illustrates another side view of the shank assembly of the agricultural implement shown in FIG. 1, particularly illustrating one embodiment of radar sensors configured to emit output signals directed at a portion of the field positioned aft and fore of the ground-engaging tool and receive reflections of the output signals as echo signals in accordance with aspects of the present subject matter:

FIG. 4 illustrates a schematic view of one embodiment of a system for determining shank attachment member loss of a ground-engaging tool of the agricultural implement shown in FIG. 1 in accordance with aspects of the present subject matter:

FIG. 5 illustrates a flow diagram providing one embodiment of control logic for determining shank attachment member loss of a ground-engaging tool of an agricultural implement in accordance with aspects of the present subject matter; and

FIG. 6 illustrates a flow diagram of one embodiment of a method for determining shank attachment member loss of a ground-engaging tool of an agricultural implement in accordance with aspects of the present subject matter.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For example, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to systems and methods for determining shank attachment member loss of an agricultural implement. As will be described below, the agricultural implement includes one or more ground-engaging tools. Each ground-engaging tool, in turn, includes a shank coupled to the implement frame and a shank attachment member (e.g., tillage point) coupled to the shank. In this respect, as the agricultural implement travels across the field to perform an agricultural operation (e.g., a tillage operation) thereon, the shank attachment member(s) is moved through the soil. However, in certain instances, one or more shank attachment members may detach from the corresponding shank(s).

In several embodiments, a computing system of the disclosed system is configured to determine when there is a loss of a shank attachment member. Specifically, in several embodiments, one or more radar sensors may be configured to emit output signals directed at a portion of the field positioned aft of the ground-engaging tool and receive reflections of the output signals as echo signals. In this respect, the computing system is configured to determine a density profile of the portion of the field positioned aft of the ground-engaging tool(s) based on the echo signals received by the radar sensor(s). Furthermore, the computing system may analyze the determined density profile to determine when a shank attachment member has been lost. For example, when a shank attachment member detaches from its shank, it may become embedded in the field surface aft of the agricultural implement. Moreover, the shank attachment member generally has a much greater density than the soil within the field. In this respect, the computing system may determine when the density value of a portion of the density profile exceeds a predetermined threshold value. Thereafter, when the density value of a portion of the density profile exceeds a predetermined threshold value, the computing system may determine that a shank attachment member has detached.

Determining when a shank attachment member has detached or otherwise become lost based on a density profile of the portion of the field positioned aft of the ground-engaging tool(s) improves the operation of the agricultural implement. More specifically, it can be difficult for an operator to visually identify when a shank attachment member has been lost as other tools, dust, and the like generally block the operator's line of sight to the shank attachment members. However, as described above, with the disclosed system and method, the density profile of the field aft of the implement can be analyzed to identify any lost shank attachment members. Thus, the disclosed system and method allow for quick determination of lost shank attachment members, thereby allowing the operator to take corrective action more quickly and/or find the lost shank attachment member(s).

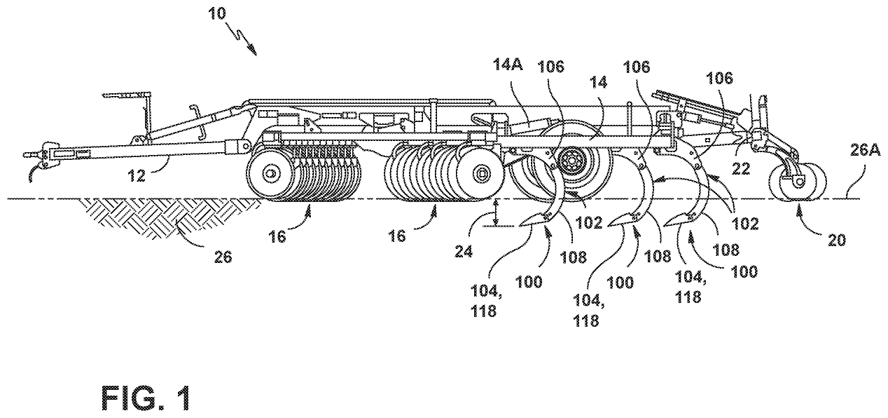

Referring now to the drawings, FIG. 1 illustrates one embodiment of an agricultural implement 10 in accordance with aspects of the present subject matter. In the illustrated embodiment, the implement 10 is configured as a tillage implement, such as a disk ripper. In such an embodiment, the agricultural implement 10 may be used to till a field to prepare the soil by plowing, ripping, turning, and/or the like. In doing so, a portion of the soil residue, such as plant stalks and/or weeds, may be removed during the tilling process. In addition, the soil may be loosened and aerated, which in turn facilitates deeper penetration of roots. The tilling process may also help in the growth of microorganisms present in the soil and thus, maintain the fertility of the soil. However, in alternative embodiments, the agricultural implement 10 may be configured as any other suitable type of implement, such as a seed-planting implement, a fertilizing implement, and/or the like.

As shown in FIG. 1, the agricultural implement 10 includes a tow bar 12 having a coupling mechanism, such as a hitch, used to couple the agricultural implement 10 to a towing vehicle (not shown), such as a tractor. The agricultural implement 10 may also include a frame 14 and a plurality of ground-engaging tools coupled to or otherwise supported by the frame 14, such as one or more disk blades, plows, chisels, hoe openers, tillage points, rolling baskets, and/or the like. For example, in the illustrated embodiment, the agricultural implement 10 includes a plurality of forward disc blades 16, a plurality of shank assemblies 100, and a plurality of soil-leveling discs 20 coupled to the frame 14, with the shank assemblies 100 being located aft of the forward disc blades 16 on the frame 14 and the soil-leveling discs 20 being positioned aft of the shank assemblies 100 on the frame 14 (e.g., via an associated tool bar 22). The frame 14 may be configured to be actuated relative to the ground 26 between a raised position and a lowered or working position by one or more frame actuators 14A.

As shown in FIG. 1, in one embodiment, each shank assembly 100 may include both a shank 102 pivotally coupled to the implement frame 14 at one end and a shank attachment member 104 coupled to the shank 102 at its opposed end. In the embodiment shown, each shank attachment member 104 corresponds to a tillage point 118. The tillage points 118 may be configured to enable high-speed operation of the agricultural implement 10 while still producing a smooth soil surface. As shown in the illustrated embodiment, the shank assemblies 100 are positioned to till a field at a depth 24 below the field or ground surface 26A, with the depth 24 of the tillage points 118 being adjustable by raising or lowering the shank assemblies 100 and/or the portions of the frame 14 relative to the field. For example, the depth 24 may be adjusted, as desired, based on local farming practices and/or field conditions. For purposes of discussion, the present subject matter will generally be described with reference to the illustrated tillage points 118. However, it should be appreciated that, in other embodiments, each shank attachment member 104 may correspond to any other ground-engaging member configured to be coupled or attached to the distal end of a shank 102, e.g., chisels, hoe openers, and/or the like.

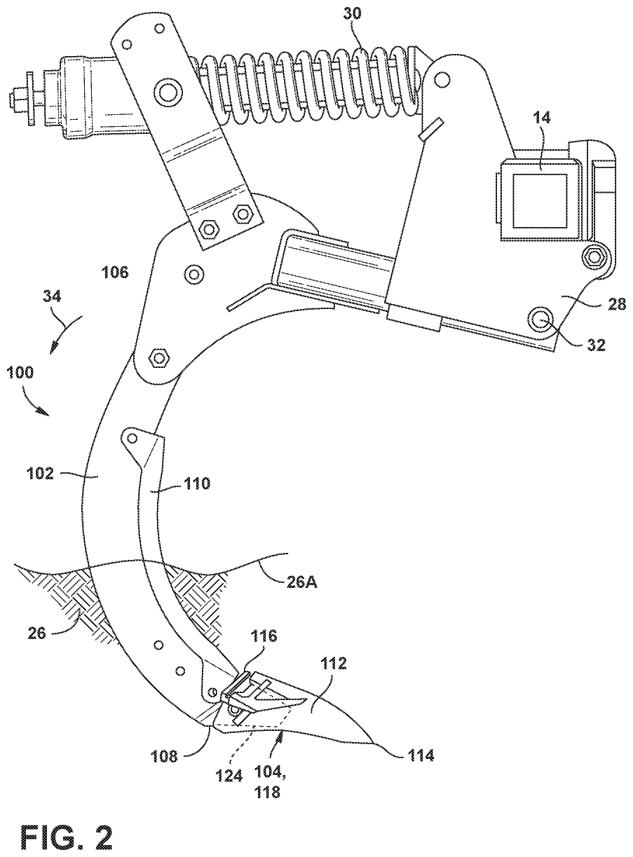

Referring now to FIG. 2, a side view of an example embodiment of a shank assembly 100 suitable for use with an agricultural implement 10 (e.g., the agricultural implement 10 shown in FIG. 1) is illustrated in accordance with aspects of the present subject matter. It should be appreciated that, for purposes of discussion, the shank assembly 100 will be described with reference to the agricultural implement 10 shown in FIG. 1. However, those of ordinary skill in the art will readily appreciate that the disclosed shank assemblies 100 may be utilized with any suitable agricultural implements having any other suitable implement configuration(s).

In general, as shown in FIG. 2, the shank assembly 100 may include a shank 102 configured to be pivotally coupled to the implement frame 14 and a tillage point 118 configured to be coupled to the shank 102. For example, the shank 102 may extend lengthwise between a proximal end 106 and a distal end 108, with the proximal end 106 being configured to be coupled to the implement frame 14 (FIG. 1), e.g., via a mount 28 rigidly coupled to the implement frame 14, and the distal end 108 being configured to be coupled to the tillage point 118. As shown in FIG. 2, the shank assembly 100 may also include a biasing member 30 (e.g., a spring) coupled between the shank 102 and the mount 28 to bias the shank 102 towards its ground-engaging position relative to the frame (e.g., the position shown in FIG. 2). For example, the biasing member 30 may bias the shank 102 downwardly such that the shank pivots about a pivot point 32 defined between the shank 102 and the mount 28 back towards its ground-engaging position (e.g., in pivot direction indicated by arrow 34) following temporary pivotal movement of the shank 102 in the opposite direction as the shank 102 encounters rocks or other impediments in the field during operation of the agricultural implement 10.

Still referring to FIG. 2, the tillage point 118 may generally include a body 112 extending lengthwise between a tip end 114 and an opposed retention end 116. In general, the tip end 114 of the tillage point 118 may be configured to enable high-speed operation of the agricultural implement 10, while still producing a smooth soil surface 26A. For example, in one embodiment, the orientation of the tip end 114 of the body 112 may be angled downwardly with respect to a horizontal plane of movement of the tillage point 118 through the soil 26, which may reduce the overall amount of drag on the body 112 during operation of the agricultural implement 10. In addition, the tip end 114 of the body 112 may be substantially flat in the lateral or cross-wise direction of the body 112, thereby further reducing drag on the body 112. However, in other embodiments, the tip end 114 of the tillage point 118 may have any other suitable configuration that allows the tillage point 118 to generally function as described herein. Moreover, the retention end 116 of the body 112 may generally be configured to allow the distal end 108 of the shank 102 to be coupled to the tillage point 118. For example, in one embodiment, the body 112 includes a retention slot 124 defined therein for receiving the distal end 108 of the shank 102.

In one embodiment, as is particularly shown in FIG. 2, the tillage point 118 is coupled to the distal end 108 of the shank 102, for example, via one or more fasteners (not shown). As the tillage point 118 is used to till the soil 26, the fastener(s) (not shown) coupling the tillage point 118 to the shank 102 become loosened or fatigued, and, as a result, may shear or fall out causing the tillage point 118 to fall out. Several systems and methods will be described below in detail for determining when the shank attachment member 104 (e.g., tillage point 118) has detached from the shank 102.

It should be appreciated that the embodiment of the shank assembly 100 of the agricultural implement 10 described above and shown in FIGS. 1 and 2 is provided only to place the present subject matter in an exemplary field of use. Thus, it should be appreciated that the present subject matter may be readily adaptable to any manner of shank assembly configuration.

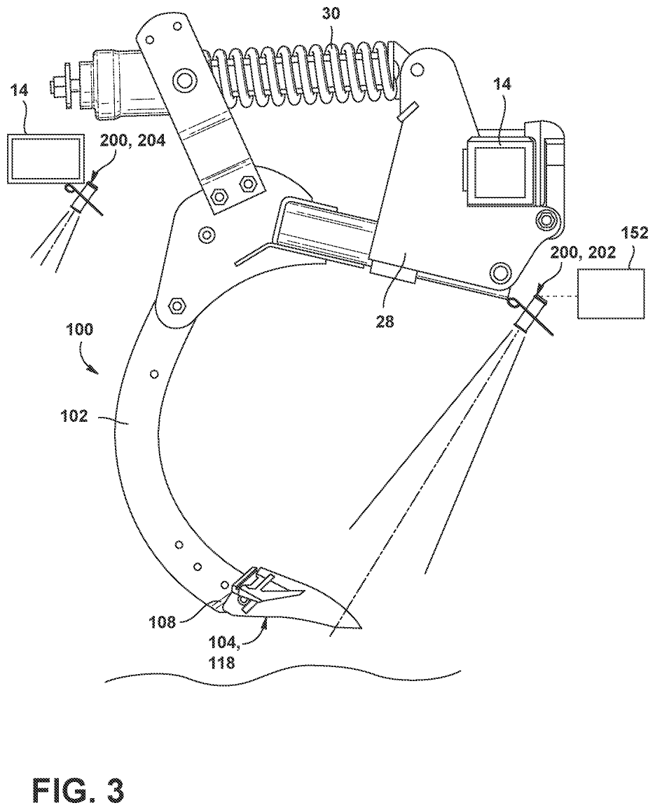

Referring now to FIG. 3, another side view of one embodiment of the shank assembly 100 shown in FIG. 2, including radar sensors configured to emit output signals directed at a portion of a field positioned aft and fore of the ground-engaging tool and receive reflections of the output signals as echo signals, is illustrated in accordance with aspects of the present subject matter. In several embodiments, the agricultural implement 10 may include one or more sensors that are used to determine when the shank attachment member 104 (e.g., tillage point 118) has detached from the shank 102, such as one or more radar sensors 200 configured to emit output signals directed at a portion of a field positioned aft of the shank assembly 100 and receive reflections of the output signals as echo signals. A computing system 152 may be communicatively coupled to radar sensor(s) 200.

In several embodiments, the agricultural implement 10 may include one or more first radar sensors 204 and one or more second radar sensors 202. Specifically, the first radar sensor 204 may be configured to emit output signals directed at a portion of a field positioned aft of the shank assembly 100 and receive reflections of the output signals as echo signals. Conversely, the second radar sensor 202 may be configured to emit output signals directed at a portion of a field positioned forward of the shank assembly 100 and receive reflections of the output signals as echo signals.

Specifically, as shown in FIG. 3, each shank assembly 100 may include or be associated with the first radar sensor 204 installed or otherwise positioned remotely from the tillage point 118. For example, as shown in the illustrated embodiment, the first radar sensor 204 is fixed relative to the frame 14 of the agricultural implement 10, e.g., by being coupled to the frame 14 itself, and positioned to emit output signals directed at a portion of the field positioned aft of the shank assembly 100. As such, the first radar sensor 204 may be coupled to the frame 14 aft of the shank assembly 100 in order to be positioned to emit output signals directed at a portion of the field positioned aft of the shank assembly 100.

Likewise, as shown in the illustrated embodiment, the second radar sensor 202 is fixed relative to the frame 14 of the agricultural implement 10, e.g., by being positioned on the rigid mount 28 attached to the frame 14 and positioned to emit output signals directed at a portion of the field positioned fore of the shank assembly 100.

It should be appreciated that, although the second radar sensor 202 is shown in FIG. 3 as being secured to the rigid mount 28 of the shank assembly 100, the second radar sensor 202 may generally be installed at any suitable location on the agricultural implement 10 that allows the second radar sensor 202 to emit output signals directed at a portion of a field positioned fore of the shank assembly 100. Likewise, it should be appreciated that, although the first radar sensor 204 is shown in FIG. 3 as being secured to the frame 14 of the agricultural implement 10, the first radar sensor 204 may generally be installed at any suitable location on the agricultural implement 10 that allows the first radar sensor 204 to emit output signals directed at a portion of a field positioned aft of the shank assembly 100. However, in alternative embodiments, the implement 10 may include one or more first radar sensors 204 and/or one or more second radar sensors 202 that are not associated with particular shank assemblies 100. Additionally, in other embodiments, the implement 10 may include only the first radar sensor(s) 204.

Furthermore, the computing system 152 may be configured to determine when the shank attachment member 104 (e.g., tillage point 118) has detached from the shank 102 based on the echo signals received from the first radar sensor 204 and/or the second radar sensor 202 with each associated shank attachment member 104 (e.g., tillage point 118). In this regard, multiple radar sensors 200 may be coupled to the agricultural implement 10 (e.g., one or more first radar sensors 204 and/or one or more second radar sensors 202), the computing system 152 may be configured to determine when the shank attachment member 104 (e.g., tillage point 118) has detached from the shank 102 on all or a portion of the shanks 102 installed on the agricultural implement 10.

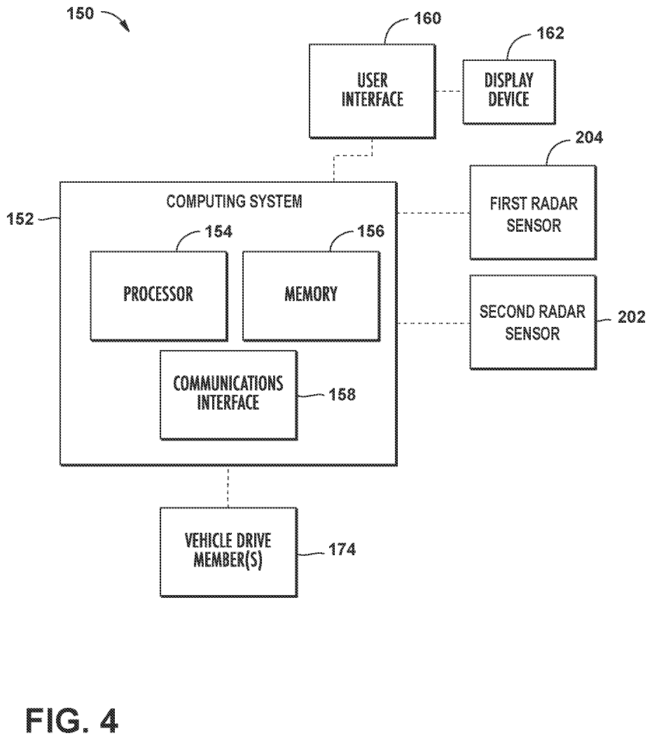

Referring now to FIG. 4, a schematic view of one embodiment of a system 150 for determining shank attachment member loss of a ground-engaging tool of the agricultural implement 10 (e.g., the presence of a tillage point in a field surface) is illustrated in accordance with aspects of the present subject matter. In general, the system 150 will be described herein with reference to the agricultural implement 10 described above with reference to FIG. 1 and the shank assembly 100 described above with reference to FIGS. 2-3. However, it should be appreciated by those of ordinary skill in the art that the disclosed system 150 may generally be used with agricultural implements 10 having any other suitable implement configuration and/or shank assemblies 100 having any other suitable shank configuration.

As shown in FIG. 4, the system 150 may include the computing system 152 configured to electronically control the operation of one or more components of the agricultural implement 10 and/or the work vehicle (not shown) to which the agricultural implement 10 is coupled. In general, the computing system 152 may comprise any suitable processor-based device known in the art, such as a computing device or any suitable combination of computing devices. Thus, in several embodiments, the computing system 152 may include one or more processor(s) 154, and associated memory device(s) 156 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 156 of the computing system 152 may generally comprise memory element(s) including, but not limited to, a computer readable medium (e.g., random access memory RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 156 may generally be configured to store suitable computer-readable instructions that, when implemented by the processor(s) 154, configure the computing system 152 to perform various computer-implemented functions, such as one or more aspects of the methods and algorithms that will be described herein. In addition, the computing system 152 may also include various other suitable components, such as a communications circuit or module, one or more input/output channels, a data/control bus and/or the like.

It should be appreciated that, in several embodiments, the computing system 152 may correspond to an existing computing system of the agricultural implement 10 and/or of the work vehicle (not shown) to which the agricultural implement 10 is coupled. However, it should be appreciated that, in other embodiments, the computing system 152 may instead correspond to a separate processing device. For example, in one embodiment, the computing system 152 may form all or part of a separate plug-in module that may be installed within the agricultural implement 10 to allow for the disclosed system and method to be implemented without requiring additional software to be uploaded onto existing control devices of the agricultural implement 10.

In some embodiments, the computing system 152 may be configured to include a communications module or interface 158 to allow for the computing system 152 to communicate with any of the various other system components described herein. For example, in several embodiments, the computing system 152 may be communicatively coupled to one or more sensors of the agricultural implement 10 that are used to determine when the shank attachment member 104 (e.g., tillage point 118) has detached from the shank 102, such as the radar sensor(s) 200 configured to emit output signals directed at a portion of a field and receive reflections of the output signals as echo signals. As shown, the computing system 152 is communicatively coupled to a first radar sensor(s) 204 configured to emit output signals directed at a portion of a field positioned aft of the shank assembly 100 and receive reflections of the output signals as echo signals. In addition, the computing system 152 is communicatively coupled to a second radar sensor(s) 202 configured to emit output signals directed at a portion of a field positioned fore of the shank assembly 100 and receive reflections of the output signals as echo signals. The computing system 152 may be communicatively coupled to the radar sensor(s) 200 via any suitable connection, such as a wired or wireless connection, to allow echo signals to be transmitted from the radar sensor(s) 200 to the computing system 152.

As will be described below, the computing system 152 may be configured to determine when the shank attachment member 104 (e.g., tillage point 118) has detached from the shank 102 based on the echo signals received from the radar sensor(s) 200. As such, the computing system 152 may include one or more suitable algorithms stored within its memory 156 that, when executed by the processor 154, allow the computing system 152 to determine when the shank attachment member 104 (e.g., tillage point 118) has detached from the shank 102 based on the echo signals received from the radar sensor(s) 200. The computing system 152 may be configured to determine when the shank attachment member 104 (e.g., tillage point 118) has detached from the shank 102 periodically, continuously, or only as demanded by an operator of the agricultural implement 10. For example, in some embodiments, the computing system 152 may receive the echo signals from one or more of the radar sensors 200 periodically based on some predetermined delay period or sampling frequency, such as after a predetermined period of time (e.g., a set amount of operating time), after a certain operating distance covered (e.g., a set amount of acres worked by the agricultural implement 10), after a certain number of actuations of the frame 14 between its raised and lowered positions, and/or the like.

In some embodiments, the computing system 152 may be configured to determine a density profile of a portion of the field positioned aft of a shank assembly 100 based on the echo signals received by the first radar sensor 204, and then determine when the shank attachment member 104 (e.g., tillage point 118) has detached from the shank 102 based on the determined density profile.

Furthermore, in some embodiments, when determining when the shank attachment member 104 (e.g., tillage point 118) has detached from the shank 102, the computing system 152 may be further configured to determine when a density value of a portion of the density profile exceeds a predetermined threshold and determine that the shank attachment member 104 (e.g. tillage point 118) has detached from the shank 102 when the density value of the portion of the density profile exceeds the predetermined threshold. For example, the predetermined threshold may be the typical density value of a tillage point 118 or other shank attachment member 104. Additionally, or alternatively, the predetermined threshold may be a maximum density value of a compacted/untilled field surface aft of the shank 102. In some additional embodiments, the computing system 152 may be further configured to determine a shape defined by the portion of the density profile exceeding the predetermined threshold value and determine that the shank attachment member 104 (e.g., tillage point 118) has detached from the shank 102 based on the determined shape. For example, the determined shape may correspond to a detached tillage point 118 or other shank attachment member 104. Moreover, in some embodiments, the computing system 152 may be further configured to compare the determined shape to a group of shapes associated with the shank attachment member and determine that the shank attachment member 104 (e.g., tillage point 118) has detached from the shank 102 when the determined shape corresponds to a shape within the group of shapes. For example, the determined shape may be compared to a group of shapes including a tillage point 118 and/or other shank attachment members 104 such that if the determined shape corresponds to a shape within the group of the shapes, the computing system 152 may determine that the shank attachment member 104 (e.g., tillage point) has detached from the shank 102.

Additionally, in some embodiments, the computing system 152 may be configured to determine when the shank attachment member 104 (e.g., tillage point 118) has detached from the shank 102 based on a comparison of the determined density profiles of portions of the field positioned aft and fore of the shank assembly 100 based on echo signals received from the radar sensor(s) 200. For example, as mentioned above, the computing system 152 may be communicatively coupled to the first radar sensor(s) 204 configured to emit output signals directed at a portion of a field positioned aft of the shank assembly 100 and to receive reflections of the output signals as echo signals. The computing system 152 may also be communicatively coupled to the second radar sensor(s) 202 configured to emit output signals directed at a portion of a field positioned fore of the shank assembly 100 and to receive reflections of the output signals as echo signals. In this respect, the computing system 152 may be configured to determine the density profile of the portion of the field positioned aft of the shank assembly(ies) 100 based on the echo signals received by the first radar sensor(s) 204 and determine the density profile of the portion of the field positioned forward of the shank assembly(ies) 100 based on the echo signals received by the second radar sensor(s) 202. As such, the computing system 152 may be configured to compare the determined density profiles of the portions of the field positioned aft and forward of the shank assembly 100 and determine when a shank attachment member(s) 104 (e.g., a tillage point(s) 118) has detached from the corresponding shank(s) 102 based on the comparison of the determined density profiles. For example, the computing system 152 may be configured to determine that the shank attachment member 104 (e.g., tillage point 118) has detached from the shank 102 when the determined density profile of the field positioned aft of the shank assembly 100 differs from the determined density profile of the field positioned forward of the shank assembly 100 by more than a predetermined amount.

Moreover, in some embodiments, the computing system 152 may be configured to determine when the shank attachment member 104 (e.g., tillage point 118) has detached from the shank 102 based on a comparison of generated representations of the conditions of the field positioned aft and fore of the shank assembly 100. For example, as mentioned above, the computing system 152 may be configured to generate a representation of the field positioned aft of the shank assembly 100 based on the echo signals received by the first radar sensor(s) 204. For example, the generated representation of the field positioned aft of the shank assembly 100 may be the density profile of the field surface with a tillage point 118 protruding therethrough. Additionally, or alternatively, the generated representation of the field positioned aft of the shank assembly 100 may be the density profile of an untilled field surface due to a missing tillage point 118 or other shank attachment member 104. Likewise, the computing system 152 may be configured to generate a representation of the field positioned forward of the shank assembly(ies) 100 based on the echo signals received by the second radar sensor(s) 202. For example, the generated representation of the field positioned forward of the shank assembly(ies) 100 may be the density profile of the field surface without a tillage point 118 protruding therethrough and/or a tilled field surface.

Additionally, the computing system 152 may be configured to compare the generated representations of the conditions of the field positioned aft and fore of the shank assembly 100 and determine that one or more shank attachment members 104 (e.g., tillage point 118) have detached from the corresponding shank(s) 102 when the comparison of the generated representations of the conditions of the field positioned aft and forward of the shank assembly(ies) 100 is indicative of a presence of a shank attachment member(s) 104 (e.g., a tillage point(s) 118) or an untilled soil condition of the field.

Furthermore, in some embodiments, the computing system 152 may be configured to initiate one or more control actions when it is determined that the shank attachment member(s) 104 (e.g., a tillage point(s) 118) has detached from the corresponding shank(s) 102. For example, the control action(s) may include notifying an operator of the agricultural implement 10 that the tillage point 118 or other shank attachment member 104 has detached from the shank 102. In the embodiment shown in FIG. 3, the communications module 158 may allow the computing system 152 to communicate with a user interface 160 having a display device 162, with the display device 162 being configured to display detachment information regarding one or more of the tillage points 118 or other shank attachment members 104. However, it should be appreciated that the computing system 152 may instead be coupled to any number of other indicators, such as lights, alarms and/or the like to provide an indicator to the operator regarding the condition of the tillage points 118 or other shank attachment members 104.

Additionally, or alternatively, in some embodiments, the control action(s) may include halting movement of the agricultural vehicle 10. In this respect, the computing system 152 may be configured to control the operation of one or more vehicle drive components 174 configured to drive a work vehicle (not shown) coupled to the implement 10, such as an engine (not shown) and/or a transmission (not shown) of the vehicle. In such embodiments, the computing system 152 may be configured to control the operation of the vehicle drive component(s) 174 when it is determined that the shank attachment member 104 (e.g., tillage point 118) has detached from the shank 102, for example, to bring the vehicle and agricultural implement 10 to a stop.

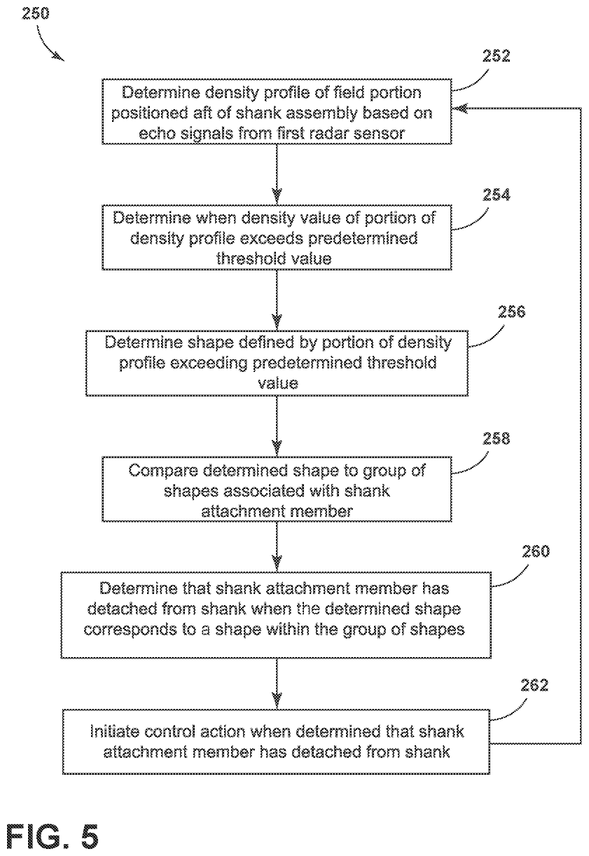

Referring now to FIG. 5, a flow diagram of one embodiment of example control logic 250 that may be executed by the computing system (or any other suitable computing system) for determining shank attachment member loss of a ground-engaging tool of an agricultural implement 10 is illustrated in accordance with aspects of the present subject matter. Specifically, the control logic 250 shown in FIG. 5 is representative of steps of one embodiment of an algorithm that can be executed to determine shank attachment member 104 loss of a shank assembly 100 of an agricultural implement 10 with improved accuracy and less false positive determinations. Thus, in several embodiments, the control logic 250 may be advantageously utilized in association with a system installed on or forming part of a work vehicle (not shown) and/or an agricultural implement to allow for real-time determination of shank attachment member loss without requiring substantial computing resources and/or processing time. However, in other embodiments, the control logic 250 may be used in association with any other suitable system, application, and/or the like for determining shank attachment member loss of a shank assembly of an agricultural implement.

As shown, at (252), the control logic 250 includes determining a density profile of the portion of the field positioned aft of the shank assembly 100 based on the echo signals received by the first radar sensor. Specifically, as mentioned above, in several embodiments, the computing system 152 may be communicatively coupled to the first radar sensor(s) 204 via the communications module or interface 158. In this respect, as the agricultural implement 10 travels across the field to perform an agricultural operation (e.g., a tillage operation) thereon, the computing system 152 may receive echo signals from the first radar sensor(s) 204. The echo signals, in turn, may be used by the computing system 152 to determine the density profile of the portion of the field positioned aft of the shank assembly(ies) 100.

Furthermore, at (254), the control logic 250 includes determining when a density value of a portion of the density profile exceeds a predetermined threshold value. Specifically, in several embodiments, the computing system 152 is configured to analyze the density profile determined at (252) to determine when the density value of any portion of the density profile exceeds the predetermined threshold value. For example, the predetermined threshold may be the typical density value of a tillage point 118 or other shank attachment member 104. Additionally, or alternatively, the predetermined threshold may be a maximum density value of a compacted/untilled field surface aft of the shank 102. As such, the computing system 152 may include suitable mathematical formula and/or algorithms stored within its memory device(s) 156 to determine when the density value of a portion of the density profile exceeds the predetermined threshold value.

Additionally, at (256), the control logic 250 includes determining a shape defined by the portion of the density profile exceeding the predetermined threshold value. Specifically, in several embodiments, the computing system 152 is configured to analyze the portion(s) of the density profile having a density value exceeding the predetermined threshold value as determined at (254). For example, the determined shape(s) may correspond to a detached tillage point 118 or other shank attachment member 104. As such, the computing system 152 may include suitable mathematical formula and/or algorithms stored within its memory device(s) 156 to determine the shape(s) defined by the portion(s) of the density profile exceeding the predetermined threshold value.

Moreover, at (258), the control logic 250 includes comparing the determined shape to a group of shapes associated with the shank attachment member. Specifically, in several embodiments, the computing system 152 is configured to compare the shape(s) determined at (256) to the group of shapes associated with the shank attachment member 104. For example, the computing system 152 may compare the determined shape(s) to a group of shapes including a tillage point 118 and/or other shank attachment members 104.

In addition, at (260), the control logic 250 includes determining that the shank attachment member has detached from the shank when the determined shape corresponds to a shape within the group of shapes. Specifically, in several embodiments, the computing system 152 may be configured to determine that the shank attachment member(s) 104 has detached from the corresponding shank(s) 102 when the shape(s) determined at (258) correspond to one of the shapes within the group of shapes.

Additionally, at (262), the control logic 250 includes initiating a control action when it is determined that the shank attachment member has detached from the shank. For example, when it is determined at (258) that a shank attachment member(s) 104 has detached from the corresponding shank(s) 102, the computing system 152 may initiate one or more control actions. In some embodiments, the control action(s) may include notifying the operator of the agricultural implement 10 that the shank attachment member(s) 104 (e.g., a tillage point(s) 118) has detached from the corresponding shank(s) 102. In this regard, the computing system 152 may transmit signals to the user interface 160. Such signals, in turn, instruct the user interface 160 to provide a visual and/or audible notification to the operator indicating that the shank attachment member(s) 104 (e.g., a tillage point(s) 118) has detached from the corresponding shank 102.

Additionally, or alternatively, the control action(s) may include halting movement of the agricultural implement 10. For example, the computing system 152 may control the operation of the vehicle drive component(s) 174 of the work vehicle (not shown) towing the agricultural implement 10 to halt movement of the agricultural implement 10. However, in alternative embodiments, the computing system 152 may be configured to initiate any other suitable control actions in addition to or in lieu of notifying the operator or halting movement of the agricultural implement 10. Furthermore, once the control logic 250 has initiated one or more control actions associated with notifying an operator that the shank attachment member 104 (e.g., tillage point 118) has detached from the shank 102 and/or halting movement of the agricultural implement 10, the control logic returns to (252).

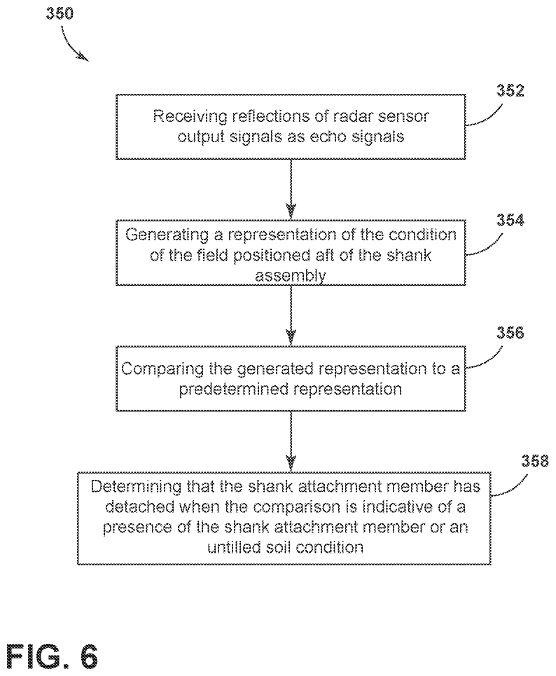

Referring now to FIG. 6, a flow diagram of one embodiment of a method 350 for determining shank attachment member loss of a ground-engaging tool of an agricultural implement 10 is illustrated in accordance with aspects of the present subject matter. In general, the method 350 will be described herein with reference to the agricultural implement 10 and the shank assembly 100 shown in FIGS. 1, 2, and 3 and the system shown in FIG. 5. However, it should be appreciated that the disclosed method 350 may be executed with implements and/or shank assemblies having any other suitable configurations and/or with systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined and/or adapted in various ways without deviating from the scope of the present disclosure.

As shown in FIG. 6, at (352), the method 350 may include receiving, with a computing device, reflections of radar sensor output signals as echo signals. For example, as indicated above, the computing system 152 may be communicatively coupled to the one or more radar sensors 200, such as the first radar sensor 204, with each radar sensor 200 being configured to emit output signals directed at a portion of a field and receive reflections of the output signals as echo signals. In particular, the first radar sensor 204 is configured to emit output signals directed at the portion of the field positioned aft of the shank assembly 100 and receive reflections of the output signals as echo signals. As described above, the echo signals may be indicative of the tillage point 118 or other shank attachment member 104 in the field surface.

Additionally, at (354), the method 350 may include generating, with the computing device, a representation of the condition of the field positioned aft of the shank assembly 100 based on the received echo signals. For example, as indicated above, the generated representation may be a density profile of a field surface with a tillage point 118 protruding therethrough.

Moreover, at (356), the method 350 may include comparing, with the computing device, the generated representation of the condition of the field positioned aft of the shank assembly 100 to a predetermined representation of the condition of the field positioned aft of the shank assembly 100. For example, the generated representation may correspond to the field surface with a detached tillage point 118 or other shank attachment member 104 protruding therethrough while the predetermined representation may correspond to the field surface with no detached tillage point 118 or other shank attachment member 104 protruding therethrough. Additionally, or alternatively, the generated representation may correspond to an untilled field surface.

Furthermore, at (358), the method 350 may include determining, with the computing device, that the shank attachment member has detached from the shank when the comparison of the generated representation to the predetermined representation is indicative of a presence of the shank attachment member or an untilled soil condition of the field. For example, the difference between the generated field surface (e.g., the detached tillage point 118 or other shank attachment member 104 protruding therethrough, untilled field surface) and the predetermined representation (e.g., the field surface with no detached tillage point 118 or other shank attachment member 104 protruding therethrough) may be noticed by the computing system 152. As such, the computing system 152 may determine that the shank attachment member has detached from the shank when the comparison of the generated representation to the predetermined representation is indicative of a presence of the shank attachment member or an untilled soil condition of the field.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An agricultural implement, comprising:
a frame;
a ground-engaging tool coupled to the frame, the ground-engaging tool including a shank and a shank attachment member coupled to the shank;
a first radar sensor configured to emit output signals directed at a portion of a field positioned aft of the ground-engaging tool, the first radar sensor further configured to receive reflections of the output signals as echo signals; and
a computing system communicatively coupled to the first radar sensor, the computing system configured to:
determine a density profile of the portion of the field positioned aft of the ground-engaging tool based on the echo signals received by the first radar sensor; and
determine when the shank attachment member has detached from the shank based on the determined density profile.

2. The agricultural implement of claim 1, wherein, when determining when the shank attachment member has detached from the shank, the computing system is further configured to:
determine when a density value of a portion of the density profile exceeds a predetermined threshold value; and
determine that the shank attachment member has detached from the shank when the density value of the portion of the density profile exceeds the predetermined threshold value.

3. The agricultural implement of claim 1, wherein, when determining when the shank attachment member has detached from the shank, the computing system is further configured to:
determine when a density value of a portion of the density profile exceeds a predetermined threshold value;
determine a shape defined by the portion of the density profile exceeding the predetermined threshold value; and
determine when the shank attachment member has detached from the shank based on the determined shape.

4. The agricultural implement of claim 3, wherein, when determining when the shank attachment member has detached from the shank, the computing system is further configured to:
compare the determined shape to a group of shapes associated with the shank attachment member; and
determine that the shank attachment member has detached from the shank when the determined shape corresponds to a shape within the group of shapes.

5. The agricultural implement of claim 1, wherein the computing system is further configured to:
initiate a control action when it is determined that the shank attachment member has detached from the shank.

6. The agricultural implement of claim 5, wherein the control action comprises notifying an operator of the agricultural implement that the shank attachment member has detached from the shank.

7. The agricultural implement of claim 5, wherein the control action comprises halting movement of the agricultural implement.

8. The agricultural implement of claim 1, wherein the first radar sensor is coupled to the frame aft of the ground-engaging tool.

9. A system for determining shank attachment member loss of a ground-engaging tool of an agricultural implement, the system comprising:
a ground-engaging tool, wherein the ground-engaging tool includes a shank and a shank attachment member coupled to the shank;
a first radar sensor, wherein the first radar sensor is configured to emit output signals directed at a portion of a field positioned aft of the ground-engaging tool, the first radar sensor further configured to receive reflections of the output signals as echo signals;
a second radar sensor, wherein the second radar sensor is configured to emit output signals directed at a portion of a field positioned fore of the ground-engaging tool, the second radar sensor further configured to receive reflections of the output signals as echo signals; and
a computing system communicatively coupled to the first radar sensor and the second radar sensor, the computing system configured to:
determine a density profile of the portion of the field positioned aft of the ground-engaging tool based on the echo signals received by the first radar sensor;
determine a density profile of the portion of the field positioned fore of the ground-engaging tool based on the echo signals received by the second radar sensor;
compare the determined density profiles of the portions of the field positioned aft and fore of the ground-engaging tool based on the echo signals received by the first radar sensor and the second radar sensor; and
determine that the shank attachment member has detached from the shank based on the comparison of the determined density profiles.

10. The system of claim 9, wherein the computing system is further configured to:
determine that the shank attachment member has detached from the shank when the determined density profile of the field positioned aft of the ground-engaging tool is greater than or equal to the determined density profile of the field positioned fore of the ground-engaging tool.

11. The system of claim 9, wherein the computing system is further configured to:
generate a representation of a condition of the field positioned aft of the ground-engaging tool based on the echo signals received by the first radar sensor;
generate a representation of a condition of the field positioned fore of the ground-engaging tool based on the echo signals received by the second radar sensor;
compare the generated representation of the conditions of the field positioned aft and fore of the ground-engaging tool; and
determine that the shank attachment member has detached from the shank when the comparison of the generated representations of the conditions of the field positioned aft and fore of the ground-engaging tool is indicative of a presence of the shank attachment member or an untilled soil condition of the field.

12. The system of claim 9, wherein the computing system is further configured to:
initiate a control action when it is determined that the shank attachment member has detached from the shank.

13. The system of claim 12, wherein the control action comprises notifying an operator of the agricultural implement that the shank attachment member has detached from the shank.

14. The system of claim 12, wherein the control action comprises halting movement of the agricultural implement.

15. A method for determining shank attachment member loss of a ground-engaging tool of an agricultural implement, the method comprising:
receiving, with a computing device, reflections of radar sensor output signals as echo signals;
generating, with the computing device, a representation of a condition of a field positioned aft of the ground-engaging tool based on the received echo signals;
comparing, with the computing device, the generated representation of the condition of the field positioned aft of the ground-engaging tool to a predetermined representation of the condition of the field positioned aft of the ground-engaging tool; and
determining, with the computing device, that the shank attachment member has detached from the shank when the comparison of the generated representation to the predetermined representation is indicative of a presence of the shank attachment member or an untilled soil condition of the field.

16. The method of claim 15, further comprising:
determining, with the computing device, a density profile of the field positioned aft of the ground engaging tool based on the echo signals received by the radar sensor; and
determining, with the computing device, that the shank attachment member has detached from the shank based on the determined density profile.

17. The method of claim 16, further comprising:
determining, with the computing device, when a density value of a portion of the density profile exceeds a predetermined threshold value; and
determining, with the computing device, that the shank attachment member has detached from the shank when the density value of the portion of the density profile exceeds the predetermined threshold value.

18. The method of claim 15, further comprising initiating, with the computing device, a control action when it is determined that the shank attachment member has detached from the shank.

19. The method of claim 18, wherein the control action comprises notifying an operator of the agricultural implement that the shank attachment member has detached from the shank.

20. The method of claim 18, wherein the control action comprises halting movement of the agricultural implement.
